(19) United States
(12) Patent Application Publication
(10) Pub. No.: US 2021/0368695 A1
(43) Pub. Date: Dec. 2, 2021

(54) PROCESS FOR GROWING PLANT WITH SMALL ELEMENT

(71) Applicant: Mankaew MUANCHART, Muang Surin (TH)

(72) Inventor: Mankaew MUANCHART, Muang Surin (TH)

(21) Appl. No.: 17/255,898

(22) PCT Filed: May 7, 2019
(86) PCT No.: PCT/TH2019/000012

§ 371 Date: Dec. 23, 2020

(30) Foreign Application Priority Data
Jun. 25, 2018 (TH) 1801003802

(51) Int. Cl. A01G 18/69; A01G 15/00; A01G 18/64

(52) U.S. Cl. CPC A01G 18/69; A01G 18/64; A01G 15/00

(57) ABSTRACT

According to aspect of the present invention there is provided process for growing plant with small element comprising of steps that involve shooting or firing high frequency to a solution containing minerals that affect plant growth. Then there was a high-frequency launch into the colloid body. Finally, the nanoparticles are created. The nanoparticle will float to the root of plant, which is suspended in the air to enrich plants and provide enough nutrients to grow. The process of plant cultivation according to the present invention was invented to develop resource reducing cultivation.

### CROSS-REFERENCE TO RELATED APPLICATIONS

This application is a U.S. National Stage entry of PCT Application No: PCT/TH2019/000012 filed May 7, 2019, which claims priority to Thai Patent Application No. 1801003802, filed Jun. 25, 2018, the contents of which are incorporated herein by reference.

### TECHNICAL FIELD

The present invention relates to biotechnology in particular the process for growing plant with small element.

### BACKGROUND

The process of growing plant is divided into 2 types, that is, soil cultivation and non-soil cultivation. Non-soil cultivation has been developed in numerous ways. Hydroponics is the process of soaking the roots with water and the roots absorb nutrients from the water. Aeroponics is the process of hanging the roots in the air and spraying water to the roots to allow the roots absorb nutrients from the water. Fogponics has been developed from aeroponics by hanging the roots in the air as well. The difference is that fogponics does not use water spray on the roots but instead reduces the size of the water by using the heatless fog. Aquaponics is a combination of plant cultivation and fishery, that is, the development of hydroponic with aquaculture or seaweed. By bringing aquatic animals or seaweed into the water used to grow plants, the plant receive nutrients from water that is mixed with waste from aquatic animals or seaweed.

Each cultivation process has different strengths and weaknesses. The soil based cropping depends on the environment and the different soil quality is careful about germs. Hydroponics is characterized by resolving the problem of soil cultivation that does not worry about quality of soil nutrient and not cautious about germs. But the downside is that the water is used in large quantities and the plants from this cultivation process have high amounts of nitrate. Because the root plants soak in water, the plants get nutrients over the desired amount in aeroponics cultivation. This must be done in the current water, otherwise the water will rot. That develop to use less water resources than hydroponics and resolve the rot water. The problem is that the tools to spray water, especially the spray to be frequent clog. Due to plant nutrients are large and clogged head of the spray. It requires frequent maintenance. It is not suitable to make in agricultural industry. Fogponics cultivation has been developed to solve the problem of aeroponics cultivation by changing from sprayed water. That makes the water smaller and the distribution of the fog to float in the desired area thoroughly. In addition, the problem of aeroponics and fogponics that the roots of the plant must always be exposed to moisture. If the roots of the plant dry up to 12 hours that will cause the plant to die. So it use in industrially that hard to maintenance because the installation of the internal fan must be placed inside the pot planted at the root of the plant. That cannot know which fan does not work. Even with the problem solving by installing sensors on the fan. But it increase production costs accompany with the pants is low cost agriculture. As a result, it is not suitable for the industry.

In addition, the time to develop each type of cultivation is longer. Soil cultivation began in the man-made period. Hydroponics began its first experiment in 1699 by John Woodward, a British scientist the 16 years later to 1860 was developed successive hydroponics. Then 51 years later, in 1911, the concept of floating plants in the air began in the journal title “Experienced Agronomy” was developed to aeroponics in 1957 by FW went and to the 46 years in develop later in the year 2000, which is 43 years away to shows the development of the fogponics. At present, fogponics cultivation are also grown in the laboratory only. And it does not appear in the agriculture industry. It can be seen that the development of each crop cultivation has a long distance period development. And the opportunity to born the new process growing plant in the world is quite small.

### SUMMARY OF INVENTION

According to the present invention is provided the process for the growing plant with small element disclosed,

The present invention is to develop a method of fogponics to next stage by turning the mist to small element and small as a nanoparticle to reduce the resources in the cultivation that is water and nutrients. Furthermore, there can be fix defective equipment easily.

The technique of the present invention is at least 2 shot frequency to plant nutrients. The 1st and 2nd shoots are fired to different plant nutrient states to make a small contribution.

### BRIEF DESCRIPTION OF THE DRAWINGS

An embodiment, incorporating all aspects of the invention, will now be described by way of example only with reference to the accompanying drawing in which:

FIG. 1 is the dramatic diagram of plant cultivation in accordance with an embodiment of the process.

FIG. 2 is the drawing of plant with the dominant features in accordance with an embodiment of the outturn process.

### DETAILED DESCRIPTION

The process of growing plants according to the present invention is to grow a plant in the chamber:

1. “chamber”. It is characterized by a closed state of the root of plant that is surrounded by walls. The closed chamber is tube or hollow or channel which is for some the air walk in the chamber. The wall made of materials that have good heat transfer properties or are insulated. The wall will have a channel for the root of the plant to hang or float in the gap. And there is a cavity that the function is to connect the solution store. The characteristic is for some the air walk such that there moves the air to flow through the inner space thoroughly.

Definition of “air walk” according to the present invention is “walk” in the graph theory of mathematics.

The process of growing plants according to the present invention is to growing plant in the chamber:

2. In case, the plant is in the kingdom of Fungi, that is to say “chamber” is characterized by a close state of the plant root that surrounded by walls. The closed chamber is tube or hollow or channel which is for some the air walk is in the chamber. The wall made of materials that have good heat transfer properties or insulated. The wall has some niche for the stem and cap to hang or floating the gaps. The mycelium area is in the outside. The function is to connect the solution store. The characteristic is some the air walk such that there moves the air to flow through the inner space thoroughly.

For the cultivation of the kingdom of Fungi. The selection of plant section that growth in the chamber which depending on the type of plant. It bring moisture in the chamber.

According to the present invention there is provided the process for growing plants with small element comprising of process as follow,

Step A: The first frequency fire. The high frequency head (3) installed at a level lower or equal to the height of the solution (2). For some or for all of them are submerged in solution in the storage tank (1). High frequency head (3) transmit high frequency spectrum higher than the sound frequency to the solution (2). The characteristic is the plant nutrients that mixing the solution.
Step B: The second wave fire. The wave shooting source (7) fire a higher frequency than the sound frequency to insert either colloid or fog solution, or both. It is different from the first frequency of step A because second wave of step B pass the air. The unique characteristic is the frequency range in the range of 1.2 to 2 megahertz.

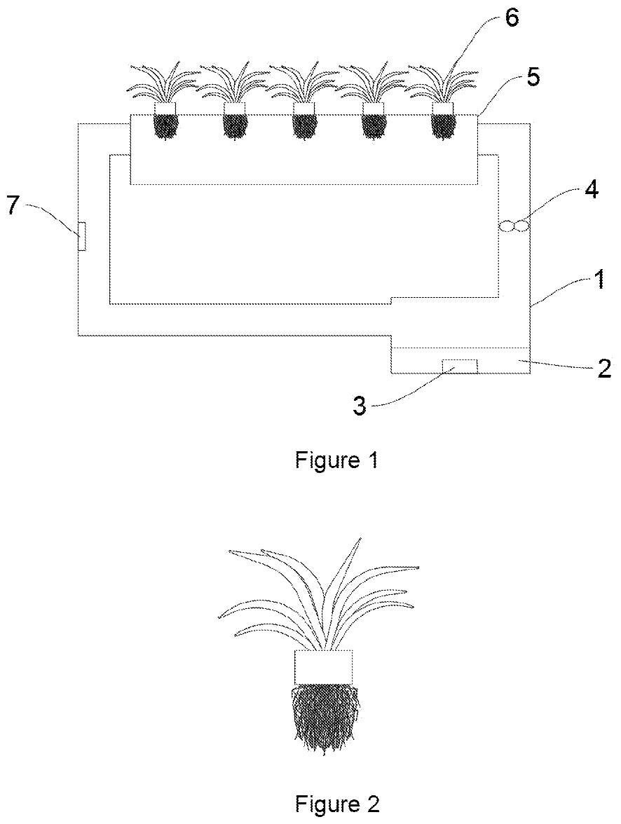

Both waves shoot to different element states. It can be described as a plantation process as shown in FIG. 1.

Steps to prepare the solution as follow, let water mix the nutrients become to solution (2) and pour into the storage tank (1). The storage tank (1) has the channel or cavity such that it has two hollow, each hollow is the air walk to the chamber (5) wherein the internal state is closed to the root of the plant.

Plant nutrients are substances that contain plant nutrients which choose from nitrogen (N), phosphorus (F), potassium (K), calcium (Ca), magnesium (Mg), sulfur (S), manganese (Mn), cupper (Cu), chlorine (Cl), iron (Fe), boron (B), zinc (Zn), molybdenum (Mo), carbon (C), hydrogen (H) or oxygen (O), at least one species. Or at least two species are mixed. In case of the cultivation of kingdom of fungi, it add more plant nutrients, that is, sulfur (S).

The step A, discloses the high frequency injection (3) such that locate at a level lower or equal to the height of the solution (2). For some or for all of them are submerged in solution in the storage tank (1). The high frequency head (3) dispenser emits the higher frequency than the sound frequency to the solution. The optimum frequency range is 1 to 6 megahertz. The best optimal frequency range is 1 to 5 megahertz, in order that the average solution element is in the range of 3 to 7 microns. The high frequency head works to heat and make the solution ripple like the boiling water. Then the fog solution float higher. Although the optimum injection is selected above condition, the size of the fog solution is not stable and varies in size. Some element weigh heavily and fall into the solution (2). Some of the smaller ones float further, but it sticks to the wall. When it combined in larger volumes, it fall into the solution (2) as well. Some of the smallest ones float along the cavity separating the two sides of the storage tank (1). The fog solution in the present stage is the cold fog such that there is the small droplet has the microparticle of different sizes.

The process of bringing the fog solution to the plant, as follows, the solution fog from the process floats into the cavity on both sides. One of the hollow have the wave shooting source (7) of Step B, which fire the second wave that explain in the next step. The other side of the cavity equip with blower (4) to absorb the fog solution from the storage tank into the cavity, for increase the distribution of the fog solution and solution is allowed to float into the chamber (5) whereas a heavy fog solution falling into the blower (4) and distillation to a drop of water stick on the blower impeller. So the blower work harder to maintain the speed of rotation. As a result, the heat of the blower increases and eventually breaks down. So Step B make the element float into the blower smaller until there is easier to fly, that is, not stick with the blower impeller. Or still stick but there volume is less with respect to the former times.

The fog solution floats to the chamber (5) has stable colloid conditions. The colloid in this region is a solid aerosol, that is, a mixture of liquid and gas. The element of fog solution stick to the plant root. Then plant take nutrient and always moist. The large fog solution fall into the chamber (5) and then they assemble to be liquid flow through the cavity back into the storage tank (1), finally. Beside, for some fog solution is not enough weight to fall to the floor, they will float to the hollow on the other side which come near the wave shooting source (7).

Step B disclose the fog solution from the afore step float into the hollow. Large volumes element flow or fall through the cavity to enter the storage tank (1). The wave shooting source (7) fire the frequency such a higher frequency than the sound frequency to either a colloid or fog solution, or both. The optimal frequency range is 1.2 to 2 megahertz. If frequency is less than 1.2 megahertz, element will break down lower. If frequency is more than 2 megahertz, that is unsuitable. Because the nature of colloidal be fire is the liquid aerosol type. When the fire wave occur, then the temperature of the hollow increase. Then there is spread the heat throughout the region. The optimal frequency ranges is 1.4 to 1.8 megahertz. Wave is fire to colloid directly, there is not shoot at the solution. That cause the size of element smaller, so that the diameter of the element is in the range of 1 to 100 nanometers or a nanoparticle whereas the characteristic is like the droplet.

The nanoparticle float slowly in the chamber (5) and the element is not nanoparticle float into the hollow through the storage tank (1). So the particle may be combined with another element and condensed into droplet and fall to the solution or stick by the wall or drift into the hollow on the other side by the force of the blower (4), which the element that pass second wave is smaller than the first frequency fire. So the element is light weight and harder to stick to the propeller. They can float to the chamber (5) faster and stick to the root of the plant. Or floating into the hollow which has the wave shooting source (7) once. The cycle is until the element is small like nanoparticle and float into the chamber (5).

The nanoparticles move in the direction of the chamber (5) because it is the only region where the exit of the nutrient from the system be absorbed by the root of the plant, and also suction by blower (4) to help element flow. When nanoparticles fly in greater quantities, the density will be maintained at relative humidity of 80 to 100%, depending on the type of crop planted. For example, the lettuce plant will maintain density of relative humidity in the range of 90 to 100%, straw mushrooms will maintain density of relative humidity of 80 to 100%. When the nanoparticles in the region increases and fly to the chamber (5) moreover, the process make the blower work less and the rotation speed is less and the amount of element stick to the blower is less respectively. So the blower do not defects. This is one of the reasons for the failure of the fan system in fogponics cultivation.

The defects of the fan associated with the water spray in cultivation, especially the cultivation of aeroponics, fogponics and the use of water spray in the cultivation of mushrooms, which is a plant in the kingdom of fungi in 2 cases. That is to say, case 1. Water is be reacted with the propeller and it rust. Case 2. The propeller works harder due to the heavy load. As a result, Blower finally burned. For solving the problem, it most will solve the problem only in the case 1., that is, to protect the fan from water by changing the fan to a waterproof fan. There is no solution to the case 2., so the launching of nanoparticles can solve the problem of cropping. And it can be used industrially. The most suitable problem solving is use waterproof blower blades coupled with the cultivation of nanoparticles.

At the storage tank (1), so the first frequency fire, Step A, is fire in addition to the thawing of the solution and the fog solution occur in different sizes. The temperature is high. The temperature in the storage tank is in the range of 26 to 50 degrees Celsius, which is not suitable for the root function. The higher the temperature will make the roots of the plants hot and die in the end. The suitable temperature at the root of the plant to absorb nutrients well is in the range of 20 to 30 degrees Celsius, but the optimum temperature of the leaves plant depends on the type of plant, such as winter plants is in the range of 15 to 20 degrees Celsius. The close environment of the root plant according to the present invention solves the problem. That is the temperature at the region of leaf plant and the region of stem plant grows well at lower temperatures than within the closed section. In addition, the material of chamber (5)'s wall with good heat transfer properties or insulated makes the heat transfer from the chamber (5) to the lower outside. As a result, the temperature in the closed chamber is reduced to between 20 and 30 degrees Celsius, which is the optimum temperature for the root of the plant. To reduce the temperature in the chamber (5) can be done another process. The temperature of chamber (5) is directed control, such as air conditioning. But this makes the nanoparticles in the system and fog solution condense to droplet and fall. This is the loss of nanoparticles that the present invention requires.

To make a single side hollow such that there is a blower (4) and a wave shooting source (7) in the hollow. And the more than two hollows can be achieved with the same result. FIG. 1 shows that the two-hollow to describe the circulation of internal element circle with clear loop.

The process of growing plant with small element can do the Step B repeatedly until there take the nanoparticle.

In case of installing a blower (4) or the wave shooting source (7) in the storage tanks (1) can be made. And the process of Step B, in this case, not only the colloids can be shot but also there can be shoot to the solution (2) whereas containing plant nutrients.

The process of Step B, can be changed to install the wave shooting sources (7) at least 2 unit such that the installation points set in the same line go to the chamber (5) but there increase cost, so it is not suitable for the agriculture industrial.

Consider the nanoparticle according to the present invention. The physical and chemical properties are as follows,

Physical properties are as follow, the Step A or the first frequency fire make the microparticle like droplet in average size from 3 to 7 microns. The large microparticles can be fire by the Step B or the second wave to be the nanoparticle until the droplet size is in the range of 1 to 100 nanometers. The each of element is smaller, so it causes space between the each of element and the air broaden out. Therefore, the space will able to contain the element increasingly, then the density of nanoparticles is higher. As a result, the space between the air and the nutrients what dissolved into nanoparticles is decrease. And the roots of plant are always moist and the volume of the solution is less than that of the larger ones.

The nanoparticles according to the present invention have a chemical effect on the plants as a follow, oxygen in the atmosphere is mixed with the substance in the storage tank (1), but because of the high temperature in the range of 26 to 50 degrees Celsius and nutrients that the food plant in the water becomes a concentrated solution. So the oxygen dissolved in water decreased. However, when the frequency fire to the solution directly, the solution dissolves into a small one and oxygen dissolved in the atmosphere better. Later, the solution containing oxygen to become a small element. The surface area is very touch. The root of plant take less nutrient absorption and oxygen absorb into the plant quickly in the right amount. Whereas oxygen affects plants to reduce the stress of plants, especially the stress of plant affects the crispness of the leaf. Hence the plant is grown belong to the present invention is less crisp and leaves plants softer than the plants grown ordinary. And because plants have a fast absorption and nutrients nanoparticles stay at the root of plant all the time. The root of the plant is different from other cultivations.

As a comparison table of the physical characteristics of the cucurbit root of each type of lettuce and each process.

| | | | | Small element |
|---|---|---|---|---|
| Root type | Soil cultivation | Hydroponics | Aeroponics | cultivation |
| root tap | Longest root tap | Root tap long | Short root tap, | No root tap or |
| | | less than root tap | root tap shorter | shortest root tap |
| | | from Soil | than root tap | |
| | | cultivation | from | |
| | | | Hydroponics | |
| lateral root | Lateral root | Lateral root | Lateral root | none |
| fibrous root | Longest, plenty | Large number | Large number | Large number and |
| | of fibrous root | and fibrous root | and fibrous root | fibrous root shorter |
| | and long | long lower than | shorter than it | than it from |
| | distributed | it from Soil | from | Aeroponics that |
| | around | cultivation that | Hydroponics that | distributed chaotic |
| | | distributed | distributed | weave such that its |
| | | around and | around | structure like figure |
| | | blown with the | | 2 |
| | | current | | |

Experiment table: Lettuce family cropping with 5 crops were harvested at 1000 per harvest. The harvesting time is from the standard weight of the plant. Display percentage of root weight versus total weight. As shown in the following table.

| | Soil | | | Small element |
|---|---|---|---|---|
| | cultivation | Hydroponics | Aeroponics | cultivation |
| | (% per total | (% per total | (% per total | (% per total |
| Root type | weight) | weight) | weight) | weight) |
| Butter head | 32-47% | 34-42% | 28-36% | 12-18% |
| Green oak | 30-40% | 35-39% | 25-37% | 12-18% |
| Red oak | 33-45% | 35-44% | 24-35% | 10-14% |

The experiments show that percentage of root weight to total weight of soil cultivation is largest. Hydroponics, aeroponics and small element cultivation is smaller in the percentage of root weight per total weight respectively. In particular, small element cultivation have a range of percentage of root weight per total weight away from the three growing process distinctly. In addition, the observations of the experiment also found.

1. The percentage of root weights per total weight of hydroponics is in the range of percentage of root weight to the total weight of soil cultivation.
2. The range of percentage of root weight per total weight of hydroponics and aeroponics will be overlap.
3. The range of percentage of root weights per total weight of small element cultivation is less and long range to the 3 types cultivation and narrow range of 4% to 6%, as a process of cultivation, the controlled system can stabilize and control the amount of nutrients provided to plants.

The table compares the period of cultivation to each stage of each growing process. The standard weight of the harvest is the end of the harvest. The period is as follows.

phase 1 is the seeding from seed to dicotyledon. Sprout and stem height above the ground in the range of 1 to 4 cm straight and strong.
Phase 2 is the timing from sprout to young plant such that growing dare with 3-4 leaves, stems straight and strong.
Phase 3 is the timing from young plant growing to the standard weight of harvest.
The table below show that the age of the butterhead:

| | Soil | | | Small element |
|---|---|---|---|---|
| | cultivation | Hydroponics | Aeroponics | cultivation |
| phase | (day) | (day) | (day) | (day) |
| phase 1 | 10-12 | 9-10 | 9-10 | 4-7 |
| phase 2 | 30-40 | 10-15 | 10-15 | 5-10 |
| phase 3 | 20-30 | 15-20 | 12-20 | 10-15 |

It can be seen that with the process for growing plant with small element according to the present invention. To reduce the growth period of the plant at all stages. The phase 1 reduces the number of days by 54 percent. Phase 2 reduces the number of days by 79 percent. Phase 3 reduces the number of days by 54 percent by using the midpoint of each period to calculate.

In addition, Step A and step B can also be used for aquaponics.

1. A process for growing a plant with a small element, the process comprising;
step A: performing a first frequency fire, wherein a high-frequency head is installed at a level lower or equal to a height of a solution such that a portion of the plant is submerged in solution in the storage and the high frequency head transmits a high frequency spectrum that is higher than the solution;
step B: performing a second wave fire, wherein a wave shooting source fires at a higher frequency than a sound frequency, to insert either colloid or fog solution, or both, and the sound frequency of step B is different from the first frequency of step A, wherein the second wave fire of the step B passes through the air and the frequency range is 1.2 to 2 megahertz.

2. The process in accordance with claim 1 wherein the Step B is performed repeatedly until a nanoparticle is generated.

3. The process in accordance with claim 1 wherein a chamber is characterized by a closed state of a root of the plant that is surrounded by walls and the closed chamber is a tube or is hollow or is a channel which is for some the air walk is in the chamber and the wall make of materials that have good heat transfer properties or insulated and the wall will have a channel for the root of the plant to hang or floating in the gap and there is a cavity that the function is to connect to the solution store and the characteristic is for some the air walk such that there moves the air to flow through the inner space thoroughly.

4. The process in accordance with claim 1, comprising;
a step to prepare the solution by letting water mix the nutrients to produce the solution and pour the solution into the storage tank;
for the step A, the high frequency injection dispenser emits the higher frequency than the sound frequency to the solution;
process of bringing the fog solution to the plant, wherein the blower absorbs the fog solution from the storage tank to increase the distribution of the fog solution that is allowed to float into the chamber;
step B, the wave shooting source fires the frequency such that a higher frequency optimal range is 1.2 to 2 megahertz to colloid, and the characteristics colloid is the liquid aerosol.

5. The process in accordance with claim 1 wherein plant nutrients are substances that contain plant nutrients which are chosen from up to two of nitrogen (N), phosphorus (F), potassium (K), calcium (Ca), magnesium (Mg), sulfur (S), manganese (Mn), cupper (Cu), chlorine (Cl), iron (Fe), boron (B), zinc (Zn), molybdenum (Mo), carbon (C), hydrogen (H) or oxygen (O).

6. The process in accordance with claim 1 further comprising waterproof blower blades associated with the cultivation of nanoparticles.

7. The process in accordance with claim 1 wherein installing a blower or the wave shooting source in one or both of the storage tanks can be made and the for step B, the colloids can be shot and the solution can be shot and contains plant nutrients.

8. The process in accordance with claim 1 wherein the step B is changed to install the wave shooting sources in at least 2 units so as to set the installation points in the same line to go to the chamber.

9. The process in accordance with claim 1 wherein when the plant is in the kingdom of Fungi, a chamber is characterized by a closed state of a root of plant that is surrounded by walls and the closed chamber is a tube or is hollow or is a channel which is for some the air walk is in the chamber and the wall made of materials that have heat transfer properties or are insulated and the wall has a niche for the stem and cap to hang or floating in the gaps, and for the mycelium area is in the outside to switch the stem and cap to mycelium such that there is a cavity, and functions to connect to the solution store and the characteristic is for some the air walk such that the air flows through the inner space thoroughly.

10. The process in accordance with claim 1 wherein for cultivation of the kingdom of Fungi, the selection of a plant section that enters the chamber depends on the type of plant, and brings moisture in the chamber.
